(19) United States
(12) Patent Application Publication
(10) Pub. No.: US 2007/0153420 A1
(43) Pub. Date: Jul. 5, 2007

(54) MAGNETIC HEAD UNIT CAPABLE OF SUPPRESSING VARIATION IN FLOATING DISTANCE FROM RECORDING MEDIUM DUE TO VARIATION IN AIR DENSITY OF ENVIRONMENT

(75) Inventor: Yasuyuki Kondo, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/562,592

(22) Filed: Nov. 22, 2006

(30) Foreign Application Priority Data
Nov. 28, 2005 (JP) 2005-341521

(51) Int. Cl. G11B 5/60

(52) U.S. Cl. 360/234.7

(57) ABSTRACT

A magnetic head unit is provided. The magnetic head unit includes a slider with a portion opposed to a recording medium. A pressing portion applies a pressing force on a recording medium and a magnetic function part installed in the trailing side of the slider. A first negative pressure generating part is disposed in the rear of the front positive pressure surface is provided on a portion opposed to the slider. A ratio of the length from the leading edge to the trailing edge of the slider to the distance from the leading edge to the front end of the first negative pressure generating part is greater than 0.4.

This application claims the benefit of Japanese Patent Application No. 2005-341521 filed Nov. 28, 2005, which is hereby incorporated by reference.

### FIELD

The present embodiments relate to a magnetic head unit having a magnetic function part in a slider opposed to a magnetic recording medium such as a hard disk.

### BACKGROUND

A magnetic head unit records a magnetic signal on a magnetic recording medium such as a hard disk and reads the magnetic signal recorded on the magnetic recording medium. The magnetic head unit has a slider opposed to the magnetic recording medium and a magnetic function part is installed at a trailing end of the slider. The magnetic function part has a reproduction function part that uses an MR effect or a GMR effect and a recording function part in which a yoke of a magnetic material, a coil, etc. are formed of a thin film.

The slider of the magnetic head unit is pressed to a surface of the magnetic recording medium by an elastic member called a loading beam. However, the slider floats from the recording medium by an airflow (air bearing) introduced between the surface of the magnetic recording medium and the slider, for example, when the magnetic recording medium rotates. A predetermined floating amount is set between the magnetic function part and the recording medium.

In the magnetic head unit, a positive pressure surface generates a floating pressure by an airflow and a negative pressure generating surface located in the rear of the positive pressure surface are formed on a side of the slider opposed to the recording medium. Generally, a floating posture and a floating amount of the slider are set by a balance of a floating force that acts on the positive pressure surface and an absorption force of the recording medium generated on the negative pressure generating surface.

Recently, the floating amount of the magnetic function part from the recording medium is recently set lowest point in order to improve magnetic recording density of the magnetic recording medium and an enhance recording speed and reproduction speed of the magnetic signal. In Patent Document 1 described below, a magnetic head unit aimed to suppress a variation in yaw angle by stabilizing a variation in floating amount in a seeking motion of moving the magnetic head between an inner circumference and an outer circumference of the recording medium when the floating amount from the recording medium such as a hard disk is reduced.

The magnetic head unit, on which a front dynamic pressure generating part and a rear dynamic pressure generating part are installed, applies a floating force on the front dynamic pressure generating part to generate a negative pressure on the rear dynamic pressure generating part. A deep hollow which neither a floating force nor a negative pressure substantially acts on is formed in an intermediate part and the dynamic posture of a head is mainly stabilized by the floating force of the front dynamic pressure generating part and the negative pressure of the rear dynamic pressure generating part.

[Patent Document 1] Japanese Unexamined Patent Application Publication No. 10-0283622

In one of the latest magnetic head units, a floating amount varies due to a variation in air density with a decrease in floating distance of a slider. When the floating distance of a slider from a magnetic recording medium decreases, a floating amount easily reduces with the reduction in air density based on a vertical drop. As a result, the slider can easily contact the surface of the recording medium when it is used at a high altitude or in an airplane.

Although the magnetic head unit described in Patent Document 1 tries to stabilize a dynamic posture of the magnetic head by applying a floating force on the front dynamic pressure generating part and applying a negative pressure on the rear dynamic pressure generating part, there is a concern of an extreme reduction in floating amount since the negative pressure generating surface that generates a negative pressure is only installed in an end of a trailing side of a slider. Accordingly, the entire slider can easily approach the recording medium with the reduction in air density of an environment.

An example of providing a negative pressure generating part in both the front dynamic pressure generating part and the rear dynamic pressure generating part is described in Patent Document 1. It is regarded that the negative pressure generating part disposed in the front and rear sides can contribute to reducing the distance between the magnetic function part and the surface of the recording medium by reducing the whole floating amount of the magnetic head. However, when the air density of an environment gets lower (i.e. higher altitude), both of the front dynamic pressure generating part and the rear dynamic pressure generating part can easily approach the recording medium. As a result, the floating distance of the slider gets easily reduced.

### SUMMARY

The present embodiments may obviate one or more of the limitations of the related art. For example, in one embodiment, a magnetic head unit is capable of suppressing a variation in floating amount due to a variation in air density of an environment varies with reduction in floating distance of a magnetic function part from a recording medium.

According to one embodiment, a magnetic head unit includes a slider with a portion opposed to a recording medium and a pressing portion that applies a pressing force on a recording medium and a magnetic function part installed in the trailing side of the slider to perform at least one of a magnetic recording function and a magnetic reproduction function. A front positive pressure surface is disposed in the leading side. A rear positive pressure surface is disposed in the trailing side. A first negative pressure generating part is disposed in the rear of the front positive pressure surface. A second negative pressure generating part disposed in the rear of the first negative pressure generating part is installed on a portion opposed to the slider. A ratio of the length from the leading edge to the trailing edge of the slider to the distance from the leading edge to the front end of the first negative pressure generating part is greater than 0.4.

In one embodiment, a floating posture of the slider (i.e. mainly, pitch angle) is decided by a floating force acting mainly on the front positive pressure surface and the rear positive pressure surface. When air density of environments gets lower, an extreme reduction in floating amount of the slider can be suppressed by a reduction in a floating force that acts on the rear positive pressure surface and a reduction in an absorption force of both negative pressure generating part.

The first negative pressure generating part and the second negative pressure generating part are all installed near to the slider's rear. An absorption force acting on the first negative pressure generating part and the second negative pressure generating part is reduced at the slider's rear part due to a reduction in air density. An extreme reduction in a floating distance of the slider's trailing side can be suppressed. A variation in the magnetic function part and the recording medium can be suppressed even though air density of environments reduces.

In one embodiment, a ratio of the length from the leading edge to the trailing edge of the slider to the distance from the leading edge to the front end of the first negative pressure generating part may be 0.5 or more.

In one embodiment, the first negative pressure generating part is divided into right and left sides and the second negative pressure generating part is divided into right and left sides. For example, a dividing portion between a pair of the first negative pressure generating parts and a dividing portion between a pair of the second negative pressure generating parts are continuously backward and forward.

When the first negative pressure generating part and the second negative pressure generating part are all installed divided into right and left, and the negative pressure generating parts are distributed in 4 places of a side opposed to the slider as above, a reduction in floating distance can be suppressed at the 4 places due to a reduction in air density. Accordingly, the floating distance of a trailing end becomes easily suppressed when the air density is reduced since a floating posture (mainly pitch angle) is stabilized.

In one embodiment, an air inlet groove that introduces air into the rear positive pressure surface may be formed at the dividing portion.

When the air inlet groove is formed at the dividing portion, a floating force at the rear positive pressure surface can always be stabilized since the air of the rear positive pressure surface can easily move.

In one embodiment, a step surface formed in the front positive pressure surface at a position lower than the front positive pressure surface are placed between the first negative pressure generating part and the leading edge, and the step surface is located backward and forward of the front positive pressure surface.

In one embodiment, the size of the front positive pressure surface according to a location of the first negative pressure generating part and the second negative pressure generating part and a negative pressure of each of the negative pressure generating part is easily set, since the front positive pressure surface is located between the front and rear step surfaces in the front of the first negative pressure generating part as described above.

By adjusting the size of the front positive pressure surface, a pitch angle of a floating posture can be prevented from extremely increasing when the first negative pressure generating part and the second negative pressure generating part are disposed in the rear part, to prevent a floating amount of the trailing edge of the slider from extremely reducing by stabilizing a floating posture.

In order to stabilize the floating posture as above, the rear end of the front positive pressure surface may be disposed in the front of the midpoint between the leading end and the trailing end, and the front end of the front positive pressure surface may be disposed in the midpoint between the leading edge and the front end of the first negative pressure generating part or in the rear of the midpoint.

In one embodiment, a low floating amount magnetic head unit that reduces a floating amount of the magnetic function part can be realized. An extreme reduction in a floating amount of the magnetic function part can be suppressed since the magnetic head floating posture is stabilized due to a variation in air density. In at least this embodiment, it becomes easier to avoid dangers such as a damage of the recording medium or a damage of a magnetic function part since a floating amount of the magnetic function part and the recording medium can be secured when used in environments with a low air density such as a high altitude or in an airplane.

### BRIEF DESCRIPTION OF THE DRAWING

FIG. 1 is a perspective view of one embodiment of the magnetic head unit with an opposed side upward.

FIG. 2 is a plan view of one embodiment of the magnetic head unit of the embodiment in an opposed side.

FIG. 3 is a plan view of one embodiment of the magnetic head unit of the modified example in an opposed side.

FIG. 4 is a plan view of one embodiment of the magnetic head unit of the modified example in an opposed side.

FIG. 5 is a plan view of one embodiment of the magnetic head unit of the comparative example 2 in an opposed side.

FIG. 6 is a lateral view of one embodiment of a support unit that supports the magnetic head unit.

FIG. 7 is a plan view of one embodiment of an opposed location of the recording medium and the magnetic head.

FIG. 8 is a linear view of one embodiment of a vertical drop sensitivity of the magnetic head of the example and the comparative example.

FIG. 9 is a linear view of one embodiment of a gap of a floating distance of the example 3 and the comparative example 2.

FIG. 10 is a linear view of one embodiment of a gap of a rolling posture of the example 3 and the comparative example 2.

### DETAILED DESCRIPTION

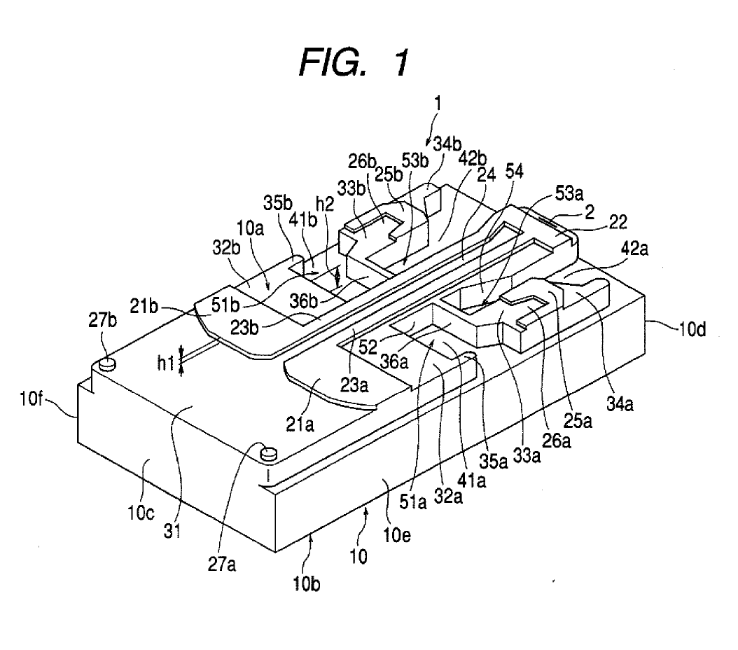

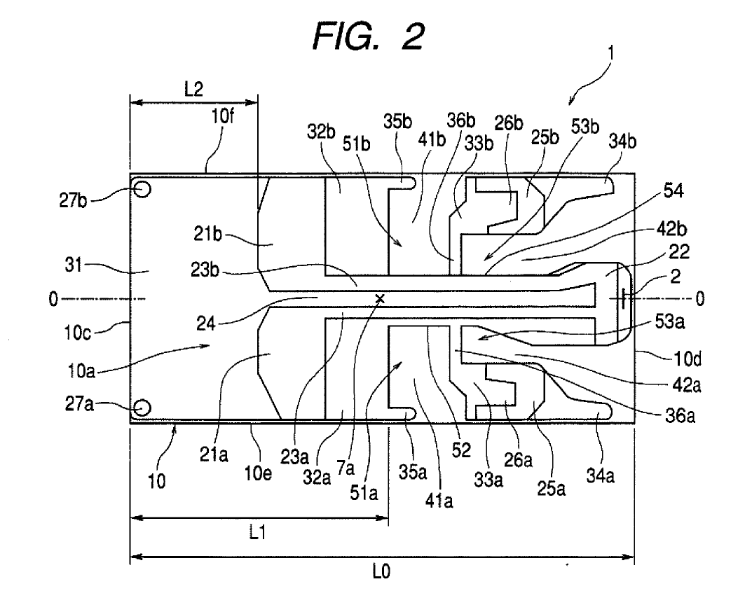

In one embodiment, as shown in FIG. 1 and FIG. 2, the magnetic head unit 1 has a cubic slider 10 formed of, for example, alumina, titan, carbide and a magnetic function part 2 mounted on the slider 10.

The magnetic function part 2 has a reading function part that reads a magnetic signal recorded on a recording medium D by using a magnetic resistant effect (an MR effect), a great magnetic resistant effect (a GMR effect) or a tunnel magnetic resistant effect (a TMR effect). A recording function part, which has a yoke of a magnetic material or a coil of a conductive material, is formed of a thin film process to record a magnetic signal on a recording medium D.

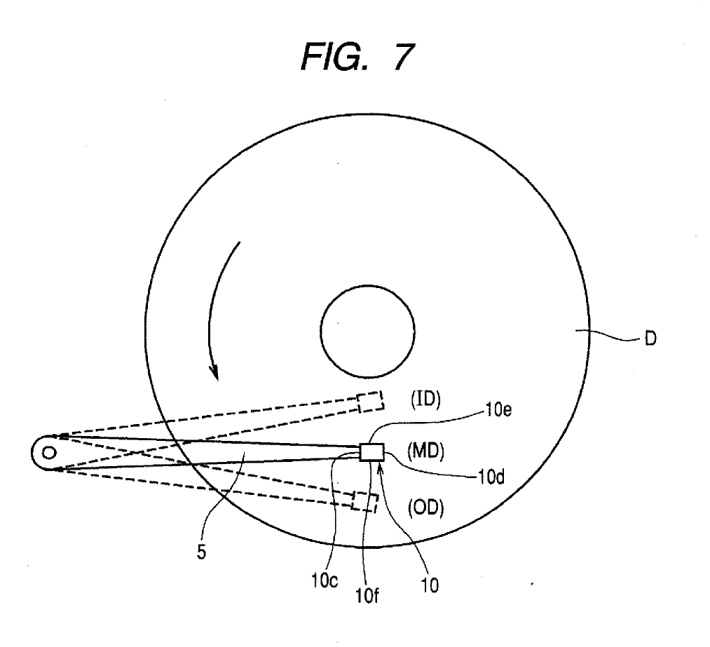

The slider 10 has an opposed side 10A opposed to the recording medium and a pressing portion 10B opposed to an opposite side of the opposed side 10A. The slider 10 has a leading edge 10C opposed to an inflowing side of an airflow generated on the recording medium D and a trailing edge 10D outflowing the airflow. The magnetic function part 2 is installed on the trailing edge 10d. The slider 10 has a inner circumference side (ID side) 10E opposed to a rotation center of the recording medium D of a magnetic recording method such as a hard disk shown in FIG. 7 and an outer circumference side (OD side) 10F opposed to an outer circumference of the recording medium.

A direction opposed to the leading edge 10C is called a front or an edge opposed to a leading edge 10C is called an front end, and there are some cases of a direction opposed to the trailing edge 10D being called a rear or an end opposed to a trailing edge 10D being called an front end. A direction parallel to a leading edge 10C and a trailing edge 10D is called a right and left direction, and there are some cases of a side opposed to the inner circumference side 10E being called a left side and a side opposed to the outer circumference side 10F being called a right side.

In FIG. 2, an imaginary line respectively dividing the leading edge 10C and the trailing edge 10D into 2 and extended in a front and rear direction is set as a centerline O-O. A center of the magnetic function part 2 is disposed on the centerline O-O.

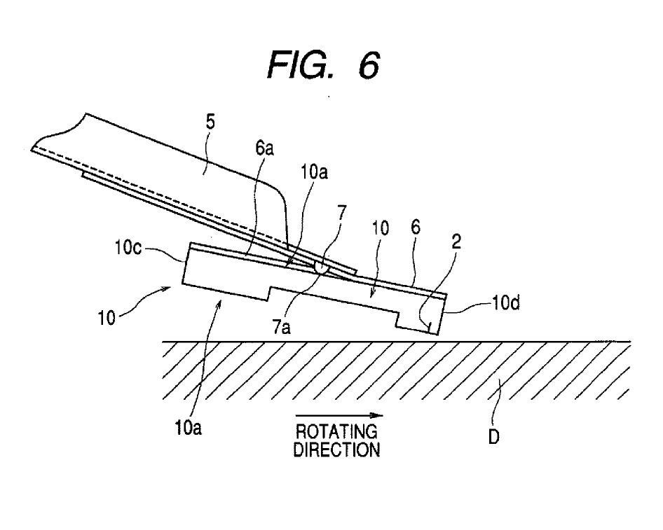

In one embodiment, as shown in FIG. 6, the pressing portion 10B of the slider 10 including the magnetic head unit 1 is supported by a supporting unit. A loading beam 5, which is an elastic support member, is installed in the supporting unit. An elastic deformation part is installed in a base of the loading beam 5. A pressing force is given to the slider 10 in a direction of the recording medium D by an elastic force of the elastic deformation part. A flexible plate 6, which is formed of an elastic plate thinner than the loading beam 5 and shows elasticity, is fixed in the front end of the loading beam 5. A surface of the pressing portion 10B of the slider 10 is adhered and fixed to a support piece 6A bent to the flexible plate 6.

In the front end of the loading beam 5 a pivot 7 projected downward is formed in a body. The pivot 7 contacts a surface of the pressing portion 10B of the slider 10 or contacts the support piece 6A. An elastic pressing force acting on the loading beam 5 acts intensively on a contact point 7A of the pressing portion 10B of the slider 10 and the pivot 7. The support piece 6A of the flexible plate 6 can be deformed in each direction. A position of the slider 10 fixed to the support piece 6A can be changed with the contact point 7A of the pivot 7 as a support point. Main directions of the position change are a pitch direction to which the centerline O-O is inclined and a rolling direction inclined right and left around the centerline O-O. As shown in FIG. 6, an angle of a floating posture of raising the leading edge 10C and a surface of the recording medium D is the pitch angle.

The contact point 7A of the pivot 7 and the slider 10 is projected in FIG. 2. The contact point 7A is located on the centerline O-O and almost in the midpoint between the leading edge 10C and the trailing edge 10D.

In one embodiment, as shown in FIG. 1 and FIG. 2, a positive pressure surface, a step surface and a negative surface are respectively formed in a plane at the opposed side 10A of the slider 10. The positive pressure surface is a plane closest to the recording medium D, and the step surface is a plane closer to the pressing portion 10B than the positive pressure surface. As shown in FIG. 1, a depth size h1 is from the positive pressure surface to the step surface is. The negative pressure surface is a plane located in the pressing portion 10B rather than the step surface, and a depth size from the step surface to the negative pressure surface is shown as h2 in FIG. 1. The depth size h2 is sufficiently larger than the depth size h1.

In one embodiment, when the recording medium D rotates while the opposed side 11A of the slider 10 faces the recording medium D, a floating force mainly acts on the positive pressure surface by an airflow (air bearing) formed on the surface of the recording medium D. Although the step surface adjusts an area of the positive pressure surface, a floating force acts a little on the step surface by the airflow or an absorption force to the recording medium D by a little negative pressure between a rear end of the positive pressure surface and the step surface. A floating force or an absorption force action on the step surface is a little of an effect on the floating posture or the floating distance of the slider 10. The depth size h1 is about 0.3 μm or less.

A negative pressure is generated at a boundary of a rear of the step surface and the negative pressure surface, and an absorption force making the recording medium D approach to the slider 10 acts by the negative pressure. For example, the depth size h2 is 1 μm to 5 μm and preferably 2.5 μm or less.

In one embodiment, an opposed side of the slider 10 is formed of a plane of 3 phases, for example, the positive pressure surface, step surface and negative pressure surface. The plane includes not only a pure plane with an infinite curvature radius, but also a curved surface with a very great curved surface.

The positive pressure surface is divided into the first front positive pressure surface 21A and the second front positive pressure surface 21B located in the leading side, a rear positive pressure surface 22 located right inside a trailing side surface 10D, and the first rear positive pressure surface 25A and the second rear positive pressure surface 25B located in front of the rear positive pressure surface 22 and at both right and left sides. Each of these positive pressure surfaces is located on the same plane.

In one embodiment, the first front positive pressure surface 21A and the second front positive pressure surface 21B are formed on a location equal in right and left having a centerline O-O therebetween. Since a flow rate of an airflow of the inner circumference of the recording medium is slower than that of the outer surface of the recording medium, by reflecting the flow rate difference, the areas of the first front positive pressure surface 21A and the second front positive pressure 21B may be a little different, for example, the area of the first front positive pressure 21A may be a little bit greater than the area of the second front positive pressure surface 21B.

A center of the rear positive pressure surface 22 in the right and left direction is located almost on the centerline O-O. An area of the rear positive pressure surface 22 is smaller than an area of the first front positive pressure surface 21A or the second front positive pressure surface 21B.

In one embodiment, a connection surface 23A is continuously extended in the front and rear direction and a regular width size is installed between the first front positive pressure 21A and the rear positive pressure surface 22, A connection surface 23B is continuously extended in the front and rear direction with a regular width size installed between the first front positive pressure 21B and the rear positive pressure surface 22. The connection surface 23A and 23B are located in the same plane as the first front positive pressure surface 21A, the second front positive pressure surface 21B and the rear positive pressure surface 22. An air inlet groove 24 is formed between the continuous surface 23A and the continuous surface 23B.

The air inlet groove 24 is open toward the front between the first front positive pressure surface 21A and the second front positive pressure surface 21B, and a rear of the air inlet groove 24 is closed at the boundary with the rear positive pressure surface 22. An air flowing from the leading edge 10C to the opposed side 10A is induced in a straight line to the rear in the air inlet groove 24 and imposed on a surface of the rear positive pressure surface 22. The rear positive pressure surface 22 can use a floating force to lift up the magnetic function part 3 from the surface of the recording medium D although the size is small.

The first rear positive pressure surface 25A is formed in a location close to the inner circumference side 10E of the slider 10. An air lead-in concave part 26A is formed in the front of the first rear negative pressure surface 25A. The second rear negative pressure surface 25B is formed at a location close to an outer circumference side 10F of the slider 10, and an air lead-in concave part 26B is formed on the front. The first rear negative pressure surface 25A and the second rear negative pressure surface 25B is located on the same plane as the first front positive pressure 21A, the second front positive pressure 21B and the rear positive pressure surface 22.

Along with the rear positive pressure surface 22, the first rear negative pressure surface 25A and the second rear negative pressure surface 25B stabilize a floating distance of the rear part of the slider 10. The first rear positive pressure surface 25A and the second rear positive pressure surface 25B stabilize a rolling posture around the centerline O-O of the slider 10 since it is disposed at both the right and left side with the centerline O-O between them.

At the inner side of the leading edge 10C and both edge of right and left, one pair of protrusions 27A and 27B are formed. Surfaces of the protrusions 27A and 27B are located on the same plane as the first front positive pressure surface 21A and the second front positive pressure surface 21B. The protrusions 27A and 27B prevent an angular part of the side surface 10E and 10F of the slider 10 and the leading side surface 10C from directly contacting a surface of the recording medium D.

The step surface has a front step surface 31, the first middle step surface 32A, the second middle step surface 32B, the first side step surface 33A, the second side step surface 33B, the first rear step surface 34A, and the second rear step surface 34B. All of these step surfaces are located on the same plane.

The front step surface 31 is formed on almost the whole area from the leading edge 10C to each front end of the first front positive pressure surface 21A and the second front positive pressure 21B. A bottom of the air inlet groove 24 is continued on the same plane as the front step surface 31. The first middle step surface 32A and the second middle step surface 32B are locate on the rear of the first front positive pressure surface 21A and the second front positive pressure surface 21B. A rib 35A extended to the rear is formed in one body at the left end of the first middle step surface 32A, and a rib 35B extended to the rear is formed in one body at the right end of the second middle step surface 32B.

The first side step surface 33A and the second side step surface 33B are located in the front of the first rear positive pressure surface 25A and the second rear positive pressure surface 25B. The first rear step surface 34A and the second rear step surface 34B are located at the rear of the first rear positive pressure 25A and the second rear positive pressure surface 25B.

A negative pressure surface 41A is formed on the rear of the first middle step surface 32A, and a negative pressure 41B is formed on the rear of the second middle step surface 32B. A space between the left negative pressure 41A and the right negative pressure surface 41B is divided by the dividing portion 52. The connection surface 23A and 23B, and the air inlet groove 24 are formed on the dividing portion 52. The first negative pressure generating surface 51A is formed by the negative surface 41A. At the first negative generating part 51A, the greatest negative pressure is generated at the part between a rear of the first middle step surface 32A and the rib 35A and the dividing portion 52. The first negative pressure generating part 51B is formed by the negative pressure surface 41B. At the first negative generating part 51B, the greatest negative pressure is generated at the part between a rear of the second middle step surface 32B and the rib 35B and the dividing portion 52.

A dividing portion 54 extending in front and rear direction is formed between the first side step surface 33A and the second side step surface 33B. The dividing portion 54 is continuously formed with the dividing portion 52. A bank portion 36A extends in a straight line in a right and left direction and is formed between the first side step surface 33A and the dividing portion 54. A bank portion 36B extends in a straight line in a right and left direction and is formed between the second side step surface 33B and the dividing portion 54. The surface of the bank portion 36A and the surface of the bank portion 36B are located on the same plane as the first side step surface 33A and the second side step surface 33B.

An area surrounded by the first side step surface 33A, the bank portion 36A and the dividing portion 54 is the second negative pressure generating part 53A. An area surrounded by the second side step surface 33B, the bank portion 36B and the dividing portion 54 is the second negative pressure generating part 53B. The area surrounding the second negative pressure generating part 53A and the second negative pressure generating part 53B is long in the front and rear direction, and the length of the negative pressure generating area in front and rear direction is longer than that of the first negative pressure generating part 51A and the first negative pressure generating part 51B. Accordingly, an absorption power of the recording medium D that acts on the second negative pressure generating part 53A and 53B is greater than an absorption power of the recording medium D that act on the first negative pressure generating part 51A and 51B.

In one embodiment, the first negative pressure generating part 51A and the first negative pressure generating part 51B are disposed by dividing them into a right and left, the second negative pressure generating part 53A and the second negative pressure generating part 53B are disposed by dividing them into a right and left, and the first negative pressure generating part 51A and 51B and the second negative pressure generating part 53A and 53B are divided into a front and rear. Accordingly, four negative pressure generating parts independent from one another and arranged parallel in front, rear, right and left are installed at an opposed side 10A of the slider 10.

As shown in FIG. 2, a length from the leading edge 10C to the trailing edge 10D of the slider 10 is LO, and a distance from an front end of the first negative pressure generating part 51A and 51B, namely a rear end of the first middle step surface 32A and the second middle step surface 32B to the leading edge 10C is L1. In one embodiment, for example, the value of L1/LO is greater than about 0.4, preferably 0.43 or more, and more preferably 0.5 or more. The distances from the first negative pressure generating part 51A and 51B to the leading part edge 10C are all located rear to 0.4×LO, namely a vicinity of the midpoint or the rear of the front and rear of the slider 10, and the second negative pressure generating part 53A and 53B are located at the rear to the first negative generating part 51A and 51B. The rear positive pressure surface 22 is located rear to the second negative pressure generating part 53A and 53B, and the first rear positive pressure surface 25A and the second rear positive pressure surface 25B is located on a position formed in the right and left direction of the second negative pressure generating part 53A and 53B.

Each rears of the first front positive pressure surface 21A and the second front positive pressure 21B are located in front of a midpoint dividing the slider 10 in 2 parts in front and rear. A distance LZ from the leading edge 10C to each front end of the first front positive pressure surface 21A and the second front positive pressure surface 21B corresponds to the L1/2 or greater than L1/2. For example, a front end of the first front positive pressure surface 21A and an front end of the second front positive pressure surface 21B are at the same location as the midpoint between a size from an front end of the front step surface 31 to the rear ends of the first middle step surface 32A and the second step surface 32B, or located rear to the midpoint.

Since the first negative pressure generating part 51A and 51B and the second negative generating part 53A and 53B are distributed in the rear of the middle part of the front and rear of the slider 10, according to above, the first front positive pressure surface 21A and the second front positive pressure surface 21B are located at a position far away in a rear direction from the leading side surface 10C and the areas of the first front positive pressure surface 21A and the second front positive pressure surface 21B is getting slightly narrow.

For example, a length LO from the leading side surface 10C to the trailing side surface 10D is about 1.24 mm, and a width size from a side 10E to a side 10F is about 0.70 mm. In the embodiment shown in FIG. 1 and FIG. 2, L1 is 0.65 mm and L1/LO is 0.524.

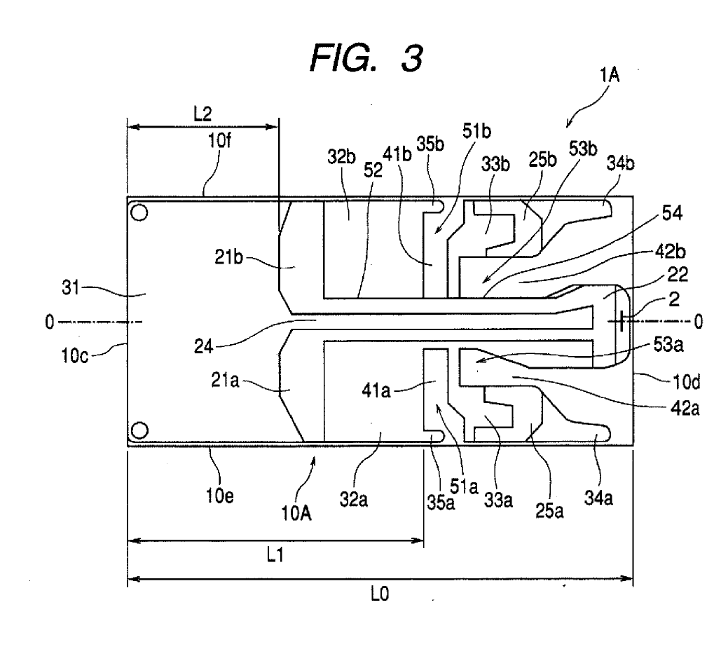

A slider 10A of a magnetic head unit 1A shown in FIG. 3 is a modified example of the embodiment. A distance L1 from the leading side surface 10C to a front end of the first negative pressure generating part 51A and 51B is about 0.73 mm, and L1/LO is 0.589. L2/L1, is a ratio of L1 to L2 which is a distance from the leading edge 10C to a front end of the first front positive pressure surface 21A and the second front positive pressure surface 21B, is about 0.5 or greater than 0.5.

A location of a front end of the first front positive pressure surface 21A and an front end of the second front positive pressure surface 21B is as the embodiment shown in FIG. 2. Since L2 of FIG. 3 is greater than L2 of FIG. 2, the areas of the first front positive pressure surface 21A and the second front positive pressure surface are getting narrower than the embodiment shown in FIG. 2. For example, in the modified example of FIG. 3, the areas of the first front positive pressure surface 21A and the second front positive pressure surface 21B is getting narrow suiting to the first negative pressure generating part 51A and 51B moving to the trailing side more than the embodiment of FIG. 2.

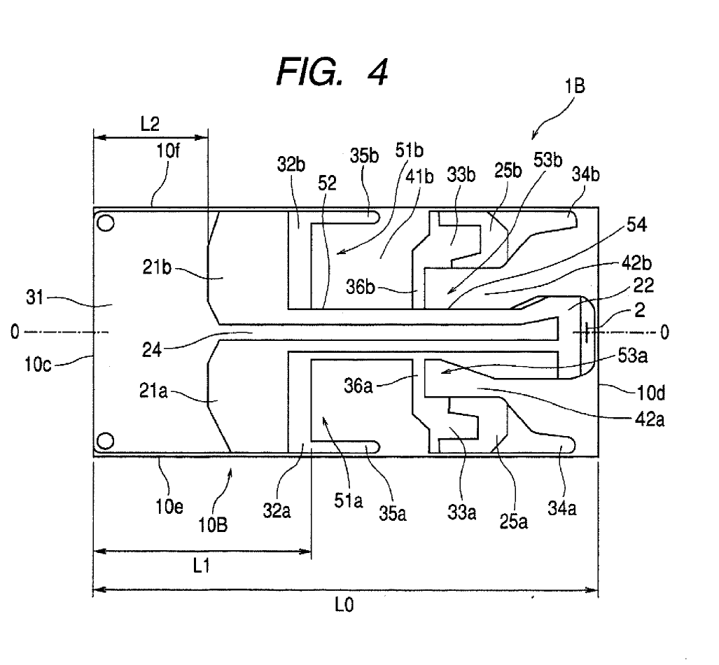

A slider 10B of a magnetic head unit 1B shown in FIG. 4 is a modified example of the embodiment. A distance L1 from the leading side surface 10C to a front end of the first negative pressure generating part 51A and 51B is about 0.54 mm, and L1/LO is 0.435. L2/L1, is a ratio of L1 to L2 which is a distance from the leading edge 10C to an front end of the first front positive pressure surface 21A and the second front positive pressure surface 21B, is about 0.5 or greater than 0.5.

A location of a front end of the first front positive pressure surface 21A and an front end of the second front positive pressure surface 21B is as the embodiment shown in FIG. 2. Since L2 of FIG. 3 is smaller than L2 of FIG. 2, the areas of the first front positive pressure surface 21A and the second front positive pressure surface are getting broader than the embodiment shown in FIG. 2. For example, in the modified example of FIG. 4, the areas of the first front positive pressure surface 21A and the second front positive pressure surface 21B is getting broad suiting to the first negative pressure generating part 51A and 51B moving to the leading side more than the embodiment of FIG. 2.

In the magnetic head unit 1 of the embodiment, the leading side 10C floats right after the recording medium D started, by an opposed airflow from a leading side to a trailing side of the slider 10 being induced between the front step surface 31 and the recording medium D. As shown in FIG. 6, the leading edge 10C become more distant from the recording medium D than the trailing edge 10D and becomes a floating posture that has a prefixed pitch angle of which the front is rising, by the airflow passing the space between the opposed side 10A of the slider 10 and the recording medium d from the leading side toward the trailing side.

In one embodiment, a positive pressure is generated at the first front positive pressure surface 21A and the second front positive pressure surface 21B, and a floating force withdrawing from the recording medium D works. The floating force also acts on the rear positive pressure surface 22, the first rear negative pressure surface 25A and the second rear negative pressure surface 25B. Since an air flowing from the leading side flows to the rear in a condition difficult to disperse the air inlet groove 24 to the right and left and induced into the rear positive pressure surface 22, a stable positive pressure is always generated in the rear positive pressure surface 22 to make a floating force work. Since the air from the air lead-in concave part 26A and 26B is induced into the first rear negative pressure surface 25A and the second rear negative pressure surface 25B, a stable positive pressure is generated in the first rear negative pressure surface 25A and the second rear negative pressure surface 25B to make a floating force work.

In one embodiment, a negative pressure is respectively generated at the first negative pressure generating part 51A and 51B and the second negative pressure generating part 53A and 53B divided into four parts. An absorption force attempting to approach the recording medium D works in the negative pressure generating part.

Although the slider 10 becomes supported from a floating force that acts on the first front positive pressure surface 21A, the second front positive pressure surface 21B, the rear positive pressure surface 22, the first rear negative pressure surface 25A and the second rear negative pressure surface 25B. Air floating from the leading side pushes up the first front positive pressure surface 21A and the second front positive pressure surface 21B and the slider 10 is drawn up and becomes a floating posture that has a predefined pitch angle as shown in FIG. 6.

A floating distance from the recording medium D to the trailing edge 10D is set low by a balance of the floating force that acts on each positive pressure surface and the absorption force acting on the first negative pressure generating part 51A and 51B and the second negative pressure generating part 53A and 53B to maintain a low floating posture.

Since an absorption force acts on each negative pressure part independent in the front, rear, right and left due to the first negative pressure generating part 51A and 51B and the second negative pressure generating part 53A and 53B being divided into four parts, a balanced absorption force acts on the slider 10 and the floating posture of the slider 10 is stabilized by the floating force acting on the four parts and the absorption force acting on the four parts.

When air density of environments reduces due to a use in a high altitude or in an airplane, a positive pressure generated on each positive pressure surface reduces to reduce the floating force. In an alternative embodiment, an absorption force is reduced due to a reduction in the negative pressure acting on the negative pressure generating part. A floating posture variation due to air density reduction and a reduction in the floating distance of the trailing edge 10D are suppressed by the balance between the reduction in the floating force and the reduction in the absorption force.

In the magnetic head unit 1 of the embodiment and the magnetic head unit 1A and 1B of the modified example, the first negative pressure generating part 51A and 51B are disposed at a rear location greater than about 0.4 of a length from the leading edge 10C to the trailing edge 1D. The second negative pressure generating part 53A and 53B are disposed at the trailing side. Accordingly, the floating force acting on the rear positive pressure surface 22, the first rear negative pressure surface 25A and the second rear negative pressure surface 25B and the absorption force acting an each negative pressure generating part located in the rear area act to balance the rear area of the slider 10. Accordingly, a reduction in a floating distance of the trailing edge 10D due to air density reduction can be suppressed.

To suit the first negative pressure generating part 51A and 51B and the second negative pressure generating part 53A and 53B located in the rear, the first front positive pressure surface 21A and the second front positive pressure surface 218 are located in a rear away from the leading edge 10C. To suit the first negative pressure generating part 51A and 51B and the second negative pressure generating part 53A and 53B located in the rear. The size of the first front positive pressure surface 21A and the second front positive pressure surface 21B are made narrow. The leading edge 10C is excessively raised up from the surface of the recording medium D can be suppressed. For example, a reduction in a floating distance of the trailing edge 10D by the pitch angle of the slider 10 becoming excessive can be suppressed.

Since a floating force acts on the first rear negative pressure surface 25A and the second rear negative pressure surface 25B with regard to both right and left sides of the second negative pressure generating part 53A and 53B, a balance with a reduction in a floating force and a reduction in an absorption force can be secured for this part when air density reduced. Accordingly, a variation in a floating posture and a floating distance of the slider 10 can be suppressed even though the air density is reduced.

### EXAMPLE

A simulation by a computer interpretation assuming a slider with the same structure as the magnetic head unit 1 of the embodiment and the magnetic head unit IA and IB of the modified example was carried out. In the simulation, a long side of the slider 10 of the magnetic head unit 1 was 124 mm, a short side 0.70 mm, a depth size h1 0.15 μm and the depth size h2 3 μm. A pressing force (loading pressure) in a direction of the recording medium D acting on a contact point 7A was 19.6 mN and the rotating number of the recording medium D was 3600 rpm.

A simulation for a comparative example and an example changing a value of L1/LO which is a ratio of a distance L1 from a leading edge 10C for the entire length LO of the slider 10 to an front end of the first negative pressure generating part 51A and 51B was carried out. As explained in the relationship between the embodiment shown in FIG. 1 and FIG. 2 and the modified example shown in FIG. 3 and FIG. 4, the comparative example and each example have the rear end's location of the first front positive pressure surface 21A and the second front positive pressure surface 21B in common, to make the sizes of the first front positive pressure surface 21A and the second front positive pressure surface 21B smaller as the first negative pressure generating part 51A and 51B are moving to the trailing side. For example, in the comparative example and each example, a floating distance of the trailing edge 10D from the recording medium D is set to be almost the same for environments in an air pressure of 1, and the floating distance of the trailing edge 10D was calculated when air density at an altitude of 3048 m (10 kilo feet) was assumed with this condition as a basis.

The example 3 of the Table 1 below corresponds to an embodiment shown in FIG. 1 and FIG. 2, the embodiment 5 corresponds to a modified example shown in FIG. 3, and the example 1 corresponds to a modified example shown in FIG. 4.

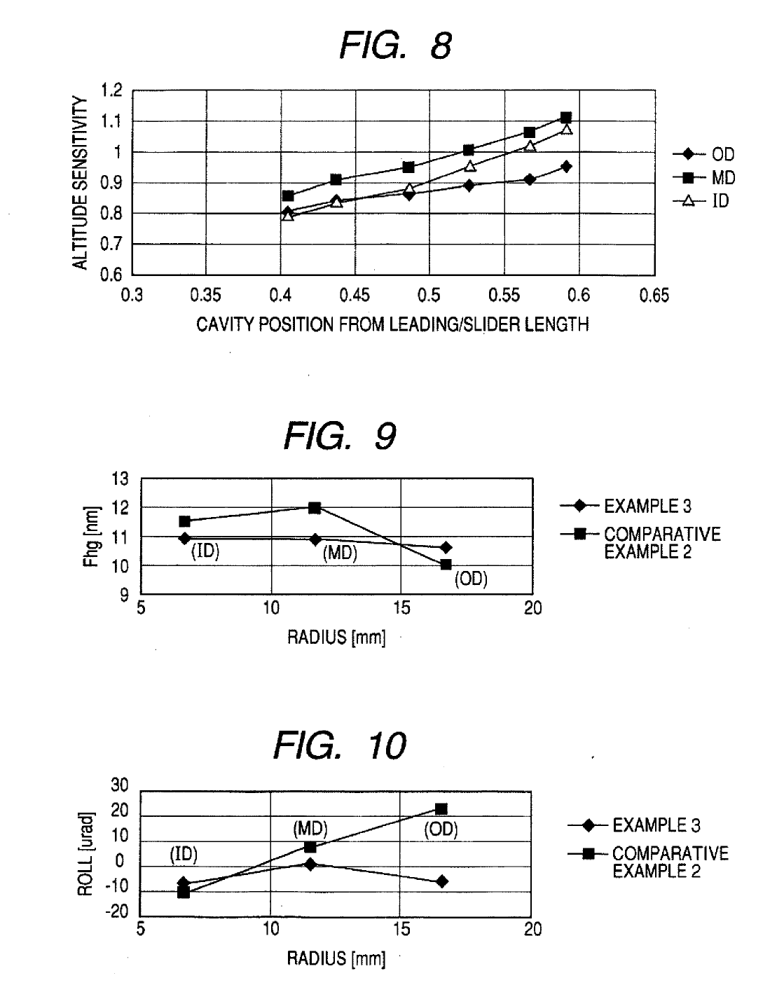

The uppermost column of Table 1 is the distance L1 (mm) of the comparative example and each example, and the second column is a ratio of L1/LO. Column 3 and below are the vertical drop sensitivities when the locations of the slider are ID, MD and OD. The vertical drop sensitivity is a ratio of a floating distance of the trailing edge 10D when assuming air density at an altitude 3048 m when a floating distance of the trailing edge 10D is “1” when a pressure of 1 is assumed to the “1.” FIG. 8 shows the result of Table 1 as a graph with a horizontal axis as L1/LO and a vertical axis as a vertical drop sensitivity.

For ID, a distance from a rotating center to a center line O-O of a slider is about 6.6 mm, that of MD is about 11.6 mm and that of OD is about 16.6 mm.

If a vertical drop sensitivity is more than 0.8 when the recording medium D is a hard disk there is not any problem for a practical use. It may be 0.84 or more, and more preferably 0.85 or more.

From Table 1 and FIG. 8, L1/LO may be 0.4 or more ore more than 0.4, preferably 0.43 or more, and more preferable 0.5 or more.

TABLE 1

| | Comparative | | | | | |
|---|---|---|---|---|---|---|
| | example | Example 1 | Example 2 | Example 3 | Example 4 | Example 5 |
| Distance to | 0.5 | 0.54 | 0.6 | 0.65 | 0.7 | 0.73 |
| an front end | | | | | | |
| (mm) | | | | | | |
| Total length | 0.4 | 0.435 | 0.484 | 0.524 | 0.565 | 0.589 |
| ratio | | | | | | |
| Vertical drop | 0.81 | 0.84 | 0.86 | 0.89 | 0.91 | 0.95 |
| sensitivity | | | | | | |
| (OD) | | | | | | |
| Vertical drop | 0.86 | 0.91 | 0.95 | 1.01 | 1.06 | 1.11 |
| sensitivity | | | | | | |
| (MD) | | | | | | |
| Vertical drop | 0.8 | 0.84 | 0.89 | 0.95 | 1.02 | 1.07 |
| sensitivity | | | | | | |
| (ID) | | | | | | |

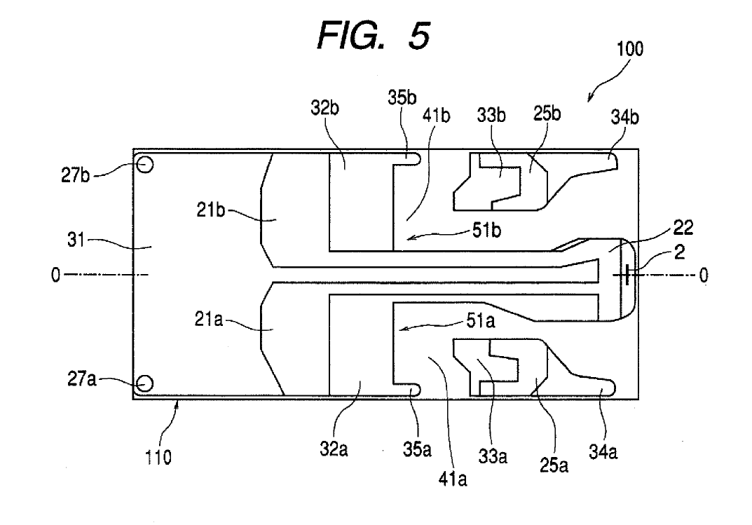

FIG. 5 shows a slider 110 of a magnetic head unit 100 of the comparative example 2. The comparative example 2 is a figure of which a bank portion 36A and 36B of an embodiment (the example 3) shown in FIG. 1 and FIG. 2 are removed, removing the second negative pressure generating part 53A and 53B and leaving only the first negative pressure generating part 51A and 51B. The rest of the structures are as the embodiments shown in FIG. 1 and FIG. 2.

A horizontal axis of FIG. 9 shows a distance from a rotation center of the recording medium D to a center line O-O of the slider, and a vertical axis shows a floating distance of a trailing edge when a pressure of 1 is assumed. A horizontal axis of FIG. 10 shows a distance from a rotation center of the recording medium D to a center line O-O of the slider, and a vertical axis shows a rolling angle (μrad) when a pressure of 1 is assumed.

In FIG. 9 and FIG. 10, compared a floating distance and a rolling angle being stable when the magnetic head unit is seeking from ID to OD in the embodiment (example 3), a floating distance and a rolling angle gets unstable in the comparative example 2. In the comparative example 2, a vertical drop sensitivity is lower than the example 3 by becoming 0.73 of ID, 0.71 of MD and 0.69 of OD. In the embodiment and the example, a floating posture and a rolling posture gets stabilized so that a reduction in a floating distance can be suppressed even though an air density is reduced by arranging 4 parts of the first negative pressure generating part 51A and 51B and the second negative pressure generating part 53A and 53B independently, and by positioning an front end of the first negative pressure generating part 51A and 51B rear to the location 0.4 times of L0 which is the total length of the slider.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A magnetic head unit comprising:
a slider with a portion opposed to a recording medium; and
a pressing portion that applies a pressing force on a recording medium and a magnetic function part installed in the trailing side of the slider,
wherein a first negative pressure generating part disposed in the rear of the front positive pressure surface is provided on a portion opposed to the slider, and
wherein a ratio of the length from the leading edge to the trailing edge of the slider to the distance from the leading edge to the front end of the first negative pressure generating part is greater than 0.4.

2. The magnetic head unit according to claim 1, wherein a ratio of the length from the leading edge to the trailing edge of the slider to the distance from the leading edge to the front end of the first negative pressure generating part is 0.5 or more.

3. The magnetic head unit according to claim 1, wherein a second negative pressure generating part is disposed in the rear of the first negative pressure generating part are installed on a portion opposed to the slider, and wherein the first negative pressure generating part is divided into a right and left side and the second negative pressure generating part is divided into right and left sides.

4. The magnetic head unit according to claim 3, wherein a dividing portion between a pair of the first negative pressure generating parts and a dividing portion between a pair of the second negative pressure generating parts are continuously backward and forward.

5. The magnetic head unit according to claim 4, wherein a front positive pressure surface is disposed in the leading side and a rear positive pressure surface is disposed in the trailing side, and wherein an air inlet groove that is operative to introduce air into the rear positive pressure surface is formed at the dividing portion.

6. The magnetic head unit according to claim 1, wherein a front positive pressure surface is disposed in the leading side and a rear positive pressure surface is disposed in the trailing side, a second negative pressure generating part disposed in the rear of the first negative pressure generating part and wherein a step surface formed in the front positive pressure surface at a position lower than the front positive pressure surface is placed between the first negative pressure generating part and the leading edge and the step surface is located backward and forward of the front positive pressure surface.

7. The magnetic head unit according to claim 1, wherein a front positive pressure surface is disposed in the leading side and a rear positive pressure surface is disposed in the trailing side, and wherein the rear end of the front positive pressure surface is disposed in the front of the midpoint between the leading end and the trailing end.

8. The magnetic head according to claim 1, wherein a front positive pressure surface is disposed in the leading side and a rear positive pressure surface is disposed in the trailing side; and wherein the front end of the front positive pressure surface is disposed in the midpoint between the leading edge and the front end of the first negative pressure generating part or in the rear of the midpoint.

9. The magnetic head according to claim 1, wherein the magnetic function part performs at least one of a magnetic recording function and a magnetic reproduction function.

10-18. (canceled)

19. A magnetic head unit that have a slider with a portion opposed to a recording medium and a pressing portion that apply a pressing force on a recording medium and a magnetic function part installed in the trailing side of the slider,
wherein a front positive pressure surface disposed in the leading side, a rear positive pressure surface disposed in the trailing side, a first negative pressure generating part disposed in the rear of the front positive pressure surface, and a second negative pressure generating part disposed in the rear of the first negative pressure generating part are installed on a portion opposed to the slider, and
wherein a ratio of the length from the leading edge to the trailing edge of the slider to the distance from the leading edge to the front end of the first negative pressure generating part is greater than 0.4.

20. The magnetic head unit according to claim 19, wherein a ratio of the length from the leading edge to the trailing edge of the slider to the distance from the leading edge to the front end of the first negative pressure generating part is 0.5 or more.

21. The magnetic head unit according to claim 19, wherein the first negative pressure generating part is divided into right and left sides and the second negative pressure generating part is divided into right and left sides.

22. The magnetic head unit according to claim 21, wherein a dividing portion between a pair of the first negative pressure generating parts and a dividing portion between a pair of the second negative pressure generating parts are continuously backward and forward.

23. The magnetic head unit according to claim 22, wherein an air inlet groove that introduce air into the rear positive pressure surface is formed at the dividing portion.

24. The magnetic head unit according to claim 19, wherein a step surface formed in the front positive pressure surface at a position lower than the front positive pressure surface is placed between the first negative pressure generating part and the leading edge and the step surface is located backward and forward of the front positive pressure surface.

25. The magnetic head unit according to claim 19, wherein the rear end of the front positive pressure surface is disposed in the front of the midpoint between the leading end and the trailing end.

26. The magnetic head according to claim 19, wherein the front end of the front positive pressure surface is disposed in the midpoint between the leading edge and the front end of the first negative pressure generating part or in the rear of the midpoint.

27. The magnetic head according to claim 19, wherein a magnetic function part is operative to perform at least one of a magnetic recording function and a magnetic reproduction function.
